(19) United States
(12) Patent Application Publication
(10) Pub. No.: US 2017/0276595 A1
(43) Pub. Date: Sep. 28, 2017

(54) Reverse Purge Flow Lenses

(71) Applicants: Riley A. Gorder, Seattle, WA (US); Igor V. Novosselov, Seattle, WA (US); George Kychakoff, Maple Valley, WA (US)

(72) Inventors: Riley A. Gorder, Seattle, WA (US); Igor V. Novosselov, Seattle, WA (US); George Kychakoff, Maple Valley, WA (US)

(21) Appl. No.: 15/330,131

(22) PCT Filed: Feb. 11, 2015
(86) PCT No.: PCT/US15/00025

§ 371 Date: Nov. 28, 2016

Related U.S. Application Data
(60) Provisional application No. 61/965,959, filed on Feb. 11, 2014.

(51) Int. Cl. G01N 21/15; B08B 17/02; B08B 5/00

(52) U.S. Cl. CPC G01N 21/15; B08B 5/00; B08B 17/02; G01N 2021/151

(57) ABSTRACT

An inspection lens, including a lens tube having a central longitudinal axis and a plurality of axially aligned optical elements, including an outermost element. A sheath surrounding the lens tube and defining there between an annular air flow channel. The sheath has a diversion nozzle at a distal end, terminating in a lens tip. The diversion nozzle is configured to divert the air flow in the annular channel inward toward the longitudinal axis and at a slight reverse angle of between 0-18 degrees relative to a plane normal to the axis and back toward the outermost element creating a reverse oblique impinging jet inside said lens tip that minimizes any recirculation zone in front of the outermost element.

This invention pertains to inspection lenses, especially to inspection lenses used in dusty environments, and to a method and apparatus for maintaining an inspection lens free from fouling by gas-borne particulates in the atmosphere where it is used.

### BACKGROUND OF THE INVENTION

Standard inspection lenses are used in installations having enclosed process spaces that require monitoring by inspection cameras. In such spaces having a heavily particle laden atmosphere, especially a high temperature atmosphere such as recovery boilers, steel manufacturing, various kilns such as cement kilns, where there is a need to protect the camera optics from heat and particulate fouling, air flow around the lens is typically provided to cool the lens and prevent fouling by the particles in the particle laden atmosphere.

A typical inspection lens is illustrated here to explain the nature of the structure and the air flow that the structure produces, and to compare it to the invention exemplified below. An inspection lens 40 of the prior art, shown in FIGS. 1A and 1B, has a lens tube 44 and an outer annular sheath 42 surrounding and radially spaced from the lens tube. A plurality of lenses 45, 46 are supported in fixed positions spaced along a longitudinal axis 47 in a lens mounting cylinder 48, along with a front lens window 41 at the forward end of the lens tube 44. An annular sheath air flow channel 50 between the outside diameter of the lens tube 44/lens mounting cylinder 48 and the annular sheath 42 carries cooling and cleaning air around the lens tube. An annular nozzle 54 attached to the distal end of the annular sheath 42 terminates at a lens tip 56. The nozzle 54 diverts the annular air flow to converge in front of the lens tip 56 via an annular flow deflector surface 60 in the nozzle. This standard lens sheath (purge) flow jet design has been in use in these environments for more than thirty years.

When a camera installation using the prior art air flow cooling and cleaning nozzle becomes unusable because of light-blocking contamination or because of breakage of the outermost optics element, the operator is faced with difficult choices. In the case of a recovery boiler, fine dust and black liquor debris can accumulate and quickly render the camera unusable by a coating of dust and other contamination on the outermost surface of the optics. The lens is not difficult to clean, but if it can become fouled quickly (for example, every 10 minutes) in an industrial environment, the instrument would typically no longer be used until its use was essential. This greatly reduces its usefulness. The diversion of manpower to perform this frequent cleaning is not acceptable, since the operator just does not have the employees available to clean the instrument every 10 minutes.

In other applications such as in steel plants like LMF and EAF (Liquid Metallurgy Furnace and Electric Arc Furnace), the process space environments not only include the possibility of high dust environments but large (millimeter sized) steel particles can impact the optics. When this happens, the front camera optics element can become covered with opaque particles or can be damaged, necessitating repairs before the system can be used again.

Thus, new sheath (purge) flow jet technology that significantly reduces (or completely eliminates) the particle deposition on the lens has long needed.

### SUMMARY OF THE INVENTION

We have discovered that the flow diversion nozzle in prior art inspection lenses produces a recirculation zone 62 (shown in FIGS. 2A and 2B) in front of the outermost optics element of the prior art inspection lens 40, which can trap dust and other particles present in the enclosed process spaces that the inspection lens is intended to monitor, and these particles eventually become deposited on the outer surface of the outermost optics element. The particulate size distribution in these enclosed process spaces can vary from nanoparticles to large droplets (10 nm-10 mm). The smaller particles (Stokes number smaller than 1) can get entrained into recirculation areas surrounding the sheath (purge) flow jet due to turbulent mixing. The larger particles (Stokes number greater than 1) can penetrate the jet due to their inertia. In addition the liquid droplets can break up (atomize) when subjected to large shear stress in the jet and will mix into the volume in front of the lens optics.

To remedy this problem, this invention provides a reverse nozzle that diverts the sheath (purge) flow jet to produce a reverse flow that converges inside the lens tip, creating a strong axial jet that is effective in keeping the particles from penetrating into the area around the lens optics. The converging reverse flow jet creates an oblique impinging jet that is focused to impinge against and along the front of the lens optics to sweep away any particles that may have intruded into the area in front of the lens and substantially reduces or completely eliminates the recirculation area on front of the lens optics, thereby significantly reducing (or completely eliminating) the particle deposition on the lens.

The inspection lens of the preferred embodiment of this invention includes a lens tube having a central longitudinal axis and a plurality of axially aligned lenses, including an outermost optics element, which can be a lens or preferably an optical window. A sheath surrounds the lens tube and defines therebetween an annular air flow channel for conveying an air flow forward. A diversion nozzle at the distal end of the sheath terminates in a lens tip. The diversion nozzle is configured to divert the air flow in the annular channel inward toward the longitudinal axis and at a slight reverse angle relative to a plane normal to the axis and back toward the outermost optics element, such that the air flow converges at the outer surface of the outermost optical element creating a reverse oblique impinging jet inside the lens tip that minimizes any recirculation zone in front of the outermost optics element and produces a strong axial jet that is effective in cleaning the lens surface by transferring air flow momentum to any particulates depositing on said lens surface.

### DESCRIPTION OF THE DRAWINGS

The invention and its many advantages and features will become better understood upon reading the following detailed description of the preferred embodiments in conjunction with the following drawings, wherein:

FIG. 1A is a sectional elevation of a standard prior art purge air tip;

FIG. 1B is a sectional perspective view of the purge air tip shown in FIG. 1A;

FIG. 2A is an air flow diagram showing air flow velocity contours around the purge air tip shown in FIG. 1A;

FIG. 2B is diagram of velocity vectors around the purge air tip shown in FIG. 1A;

FIG. 3A is a sectional elevation of an inner assembly of a purge air tip in accordance with this invention;

FIG. 3B is a sectional perspective of a complete assembly of the purge air tip shown in FIG. 3A;

FIG. 4A is an air flow diagram showing air flow velocity contours around the purge air tip shown in FIG. 3A;

FIG. 4B is diagram of velocity vectors around the purge air tip shown in FIG. 3A;

FIG. 5 is a diagram showing the range of useful angles for the reverse purge system shown in FIGS. 3A and 3B, from −7.7 degrees to “x,” where “x” is limited by the field of view of the lens objective.

### DESCRIPTION OF THE PREFERRED EMBODIMENT

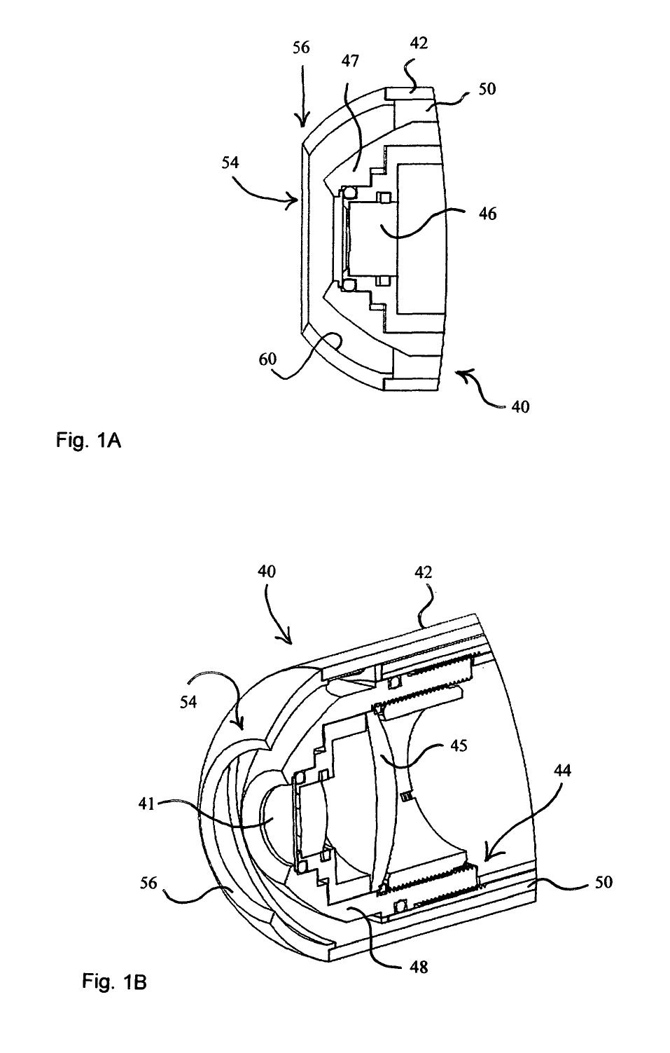

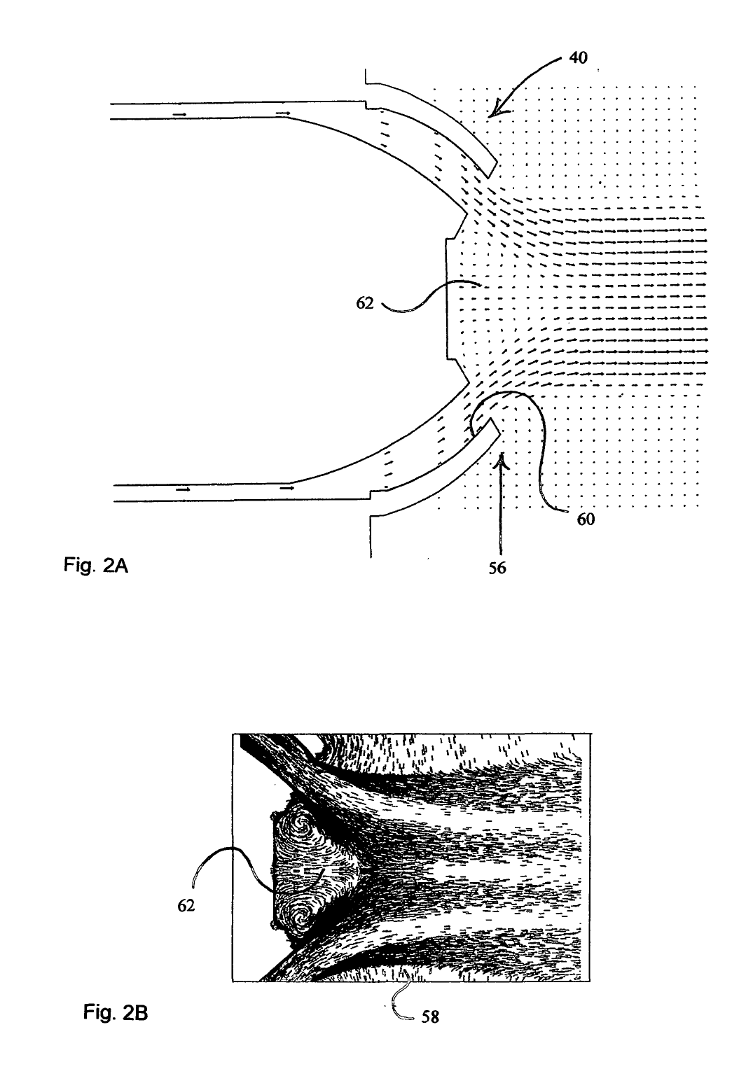

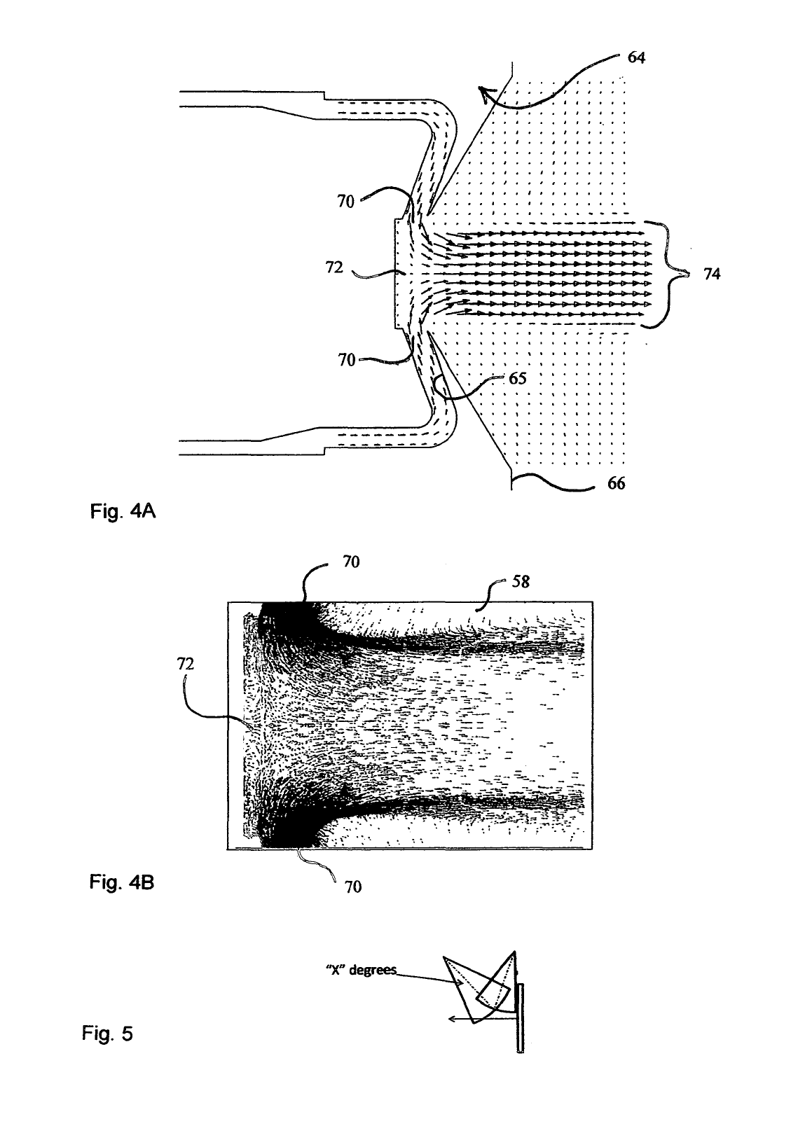

Turning now to the drawings, and more particularly to FIGS. 1A and 1B and FIGS. 2a and 2b thereof, we have found that the fouling problem that the standard furnace inspection lenses shown in FIGS. 1A and 1B suffer from are due to entrainment in the sheath air flow of particulate laden gas from the internal furnace ambient environment 58. The forward directed converging air flow creates a very stable recirculating zone 62 in front of the lens optics, as shown in FIGS. 2A and 2B. Note that in FIG. 2A (and also FIG. 4A), the gas flow velocity and direction is indicated by the flow vector lengths and arrow head size, and in FIG. 2B, (and also FIG. 4B) the density of the arrows in the vector plot is a consequence of how the computational simulation is setup. Areas of high arrow/vector density indicate regions of the computational domain that have more “cells” meaning that that region is more resolved. Note also that the entire jet is turbulent. The flow is turbulent even before it enters the stagnant (relative to the jet velocities) dirty furnace air. The figures showing gas flow velocities are time-averaged plots showing the average flow field. In time averaged plots, the chaotic turbulent fluctuations are averaged away and design decisions can be based on the “smoothed” time-averaged data. That being said, it is important to note that although the figures look like straight laminar pathlines in reality the randomness of turbulence is mixed in.

Particle laden gas is trapped in this recirculating zone 62, or eddy, in front of the frontmost optics element, inside and also forward of the lens tip 66, followed by particle deposition onto the lens optics. The physics of formation of this recirculation eddy 62, shown in FIG. 2B, is similar to the classic backward-facing step problem and it is impossible to prevent without directing flow at the center of the lens optics itself. Many particles that get entrained in this very stable recirculation zone 62 will stay in the zone for a very long time (dynamic arrest) until they deposit onto the lens optics fouling the device.

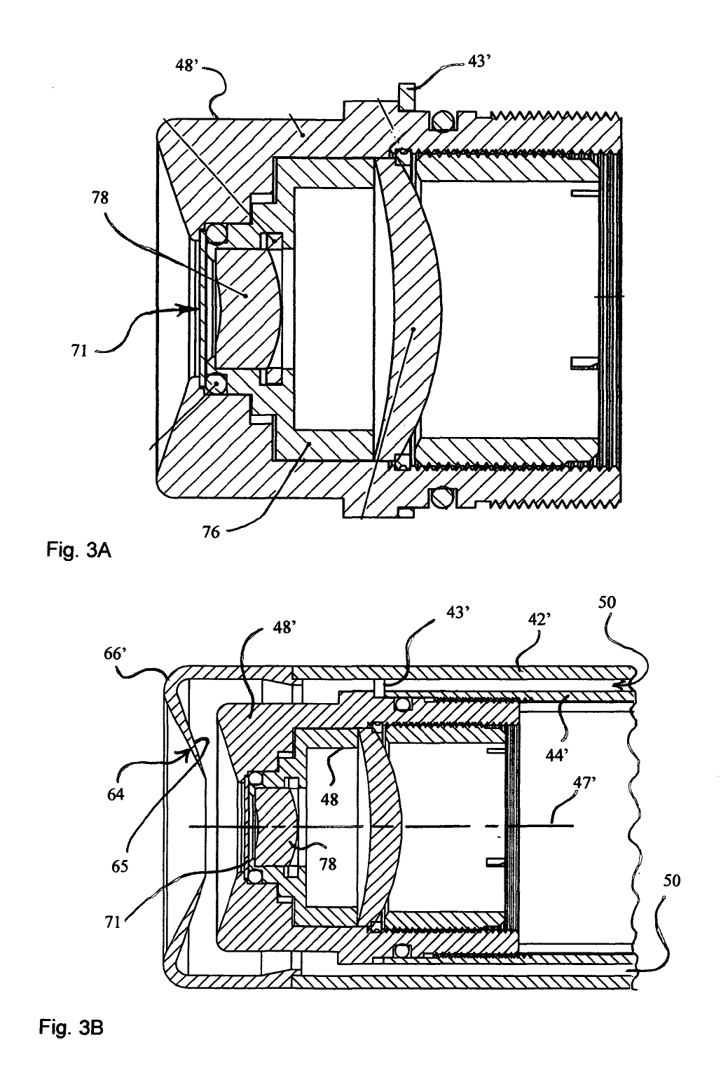

As shown in FIGS. 3A and 3B, a preferred embodiment of an inspection lens in accordance with this invention includes an outer sheath 42′ spaced from and surrounding a lens tube 44′. An annular gas flow channel 50′ is bounded on the outside by the outer sheath 42′ and on the inside by the lens tube 44′. A lens mounting cylinder 48′ is fastened to the front end of the lens tube and is held centered in the annular sheath 42′ by a castellated spacer ring 43′ which allows passage of gas along the annular gas flow channel 50′. A nozzle 64 is attached to the distal end of the outer sheath 42′ to divert the gas flow inward toward a longitudinal axis 47′.

A reverse sheath (purge) flow jet nozzle 64 in accordance with the invention diverts the gas flow inward toward a longitudinal axis 47′ to produce a converging reverse flow jet 70 focused at the front of the lens optics to substantially reduce or completely eliminate the possibility of a recirculation area forming in the region 72 immediately in front of the lens optics, thereby significantly reducing (or completely eliminating) the particle deposition on the lens. FIGS. 3A and 3B shows the reverse flow nozzle 64, and FIGS. 4A and 4B show the reverse flow jet 70 around the new flow jet nozzle 64 in accordance with the invention, showing the minimal air recirculation in the region 72 in front of the lens optics compared to FIGS. 2A and 2B. The reverse flow gas jet 70 passes through a reverse jet passage bounded by the inner nozzle surfaces 65 of the reverse jet nozzle and the complementary shaped front surface of the lens mounting cylinder 48′ to produce a high velocity annular reverse flow oblique impinging jet 70 that converges inside the lens tip directly against and long front surface of the frontmost optics element, displacing any particles that may have landed on the surface and creating a strong axial jet 74 that is effective in keeping the particles from penetrating into the area around the lens' optics. In the preferred embodiment, the frontmost optics element is a sapphire window 71, mounted between the front lens housing 76 and the lens mounting cylinder 48′ directly in front of the outermost lens 78, to protect the outermost lens.

The reverse flow lens makes a more efficient use of the air supply (by nature of the stronger jet vs the prior art for the same purge flowrate). More “efficient” than the prior art means that the same amount of air flow will provide a more focused and higher velocity jet and thus provide better overall purging of the optics region. It allows for camera systems to be installed in environments that were previously unattainable with the prior art.

The flow angle for reversed flow depends on the desired view angle; for example FIG. 3A shows the design for 120 degree view angle. The impinging jet angle in this design is about 18 degrees from vertical relative to the lens optics window (108 degrees from axial velocity component). If greater view angle is desired, an opposing jet approach can be used. In this scenario the purge jet are opposing to each other creating a jet parallel to the lens optics or perpendicular to the axial jet.

FIGS. 2B, 4B, show the differences in velocity direction and magnitude between the standard lens tip and the reverse purge flow lens tip. Shallow angle design can greatly improve the performance of the purge air by effectively strengthening the axial jet and reducing the recirculation area in front of the lens. The smaller the angle of the purge air jet relative to the axial jet, the greater the size of the recirculation area in front of the lens tip. Based on the typical jet expansion angle of 7.5 degrees we prefer purge air angles between −7.5 degrees to an angle limited by the field of view of the lens objective (see FIG. 5). The range of useful angles for the reverse purge system is about −18 degrees to one half the field of view of the lens objective, primarily to avoid partially obstructing the field of view.

Specific air flowrates and pressures are different in different industrial applications because of their different constraints, (limited air supply, limited allowable air that can be used due to the process, position of camera system, the level of dust and particles that have to be rejected, etc.) The reverse flow lens allows for installations in applications that are difficult or impossible for the prior art. For example, the new lens will reject steel splatter if enough air is supplied, but the amount of air needed by the new lens to create a strong enough axial jet to protect the optics from damage is much lower that what the prior art system can provide. The exact amount of air required changes with the specific application. Also, the reverse flow lens can be used to keep the inspection lens clean in installations where the prior art was successful, but can do so while using less air, which saves money.

Benefits of using the new design include a greatly reduced recirculation area in front of the lens and is located well inside of the lens tip. Particles and aerosol droplets are less likely to be captured in a small recirculation zone and therefore are less likely to be deposited on the optics. A much stronger axial jet is formed for the same operating conditions (purge air flow rate and pressure) which helps prevent particles from entering into the area of the lens tip. The oblique impinging gas jets against the outermost optics element greatly improves cleaning of the lens optics by the jets due to the transfer of the flow momentum to any particulates depositing onto the lens surface.

Obviously, numerous modifications and variations of the preferred embodiment described above are possible and will become apparent to those skilled in the art in light of this specification. For example, in high temperature process environments that could not use oxygen containing air as the cooling/cleaning gas, such as explosive or other highly reactive atmospheres, nitrogen, argon or CO₂ could be used as the cooling/cleaning purge gas. In process spaces having temperatures in warm or ambient temperature, an IR camera may be unsuitable because the temperature in the process space must be elevated at least 200F to get good images. However, a cooled MWIR camera would be able to get good images and use the new reverse flow lens in a dusty cool environment to maintain the dust-free condition of the lens. Therefore, we expressly intend that all these and other embodiments, species, modifications and variations, and the equivalents thereof, are to be considered within the spirit and scope of the invention as defined in the following claims, wherein we claim:

1. An inspection lens for particle laden environments, comprising:
a lens tube having a central longitudinal axis and a plurality of axially aligned lenses, including an outermost lens;
a sheath surrounding said lens tube and defining therebetween an annular air flow channel;
said sheath having a diversion nozzle at a distal end, terminating in a lens tip; said diversion nozzle configured to divert said air flow in said annular channel inward toward said longitudinal axis and at a slight reverse angle relative to a plane normal to said axis and back toward said outermost lens, such that said air flow converges at said lens surface creating a reverse oblique impinging jet that minimizes any recirculation zone in front of said outermost lens and produces a strong axial jet that is effective in cleaning said lens surface by transferring air flow momentum to any particulates depositing on said lens surface.

2. An inspection lens for particle laden environments as defined in claim 1, wherein:
said reverse oblique impinging jet converges inside said lens tip.

3. An inspection lens for particle laden environments as defined in claim 1, wherein:
said slight reverse angle is between 0-18 degrees.

4. An inspection lens for particle laden environments as defined in claim 3, wherein:
said flow angle for reversed flow is about 0-5 degrees from vertical in an opposing jet approach, wherein said annular purge jet converges radially inward creating a converging jet about parallel to the lens optics and about perpendicular to the axial jet.

5. A method of maintaining an inspection lens, operating in a heavily particle laden atmosphere, in a dust-free condition, comprising
establishing an annular flow of cleaning gas along an annular channel between an outer sheath and an inner lens tube of said inspection lens;
diverting said flow of cleaning gas at a distal end of said inspection lens at a flow angle that is radially inward to converge toward a longitudinal axis of said inspection lens at a slight reverse angle relative to a plane normal to said axis and back toward an outer surface of an outermost optics element in said inspection lens, such that said gas flow impinges against and along said outer surface, blowing dust off said outer surface and minimizing any recirculation zone in front of said outer surface of said outermost optics element.

6. A method as defined in claim 5, wherein:
said inspection lens has a field-of-view angle, and said flow angle for reversed flow is no greater than one half of said field of view angle of said lens.

7. A method as defined in claim 5, wherein:
said radially inwardly converging gas flow impinging against said outermost optical element produces a powerful focused axial gas jet that deflect particles in said atmosphere away from said distal end of said inspection lens.
